(19) United States
(12) Patent Application Publication
(10) Pub. No.: US 2015/0294395 A1
(43) Pub. Date: Oct. 15, 2015

(54) LOGISTICS MANAGEMENT SYSTEM FOR DETERMINING PICKUP ROUTES FOR RETAIL STORES

(71) Applicant: International Business Machines Corporation, Armonk, NY (US)

(72) Inventors: Ajay A. Deshpande, White Plains, NY (US); Kimberly D. Hendrix, New Albany, OH (US); Herbert S. McFaddin, Yorktown Heights, NY (US); Chandrasekhar Narayanaswami, Wilton, CT (US)

(21) Appl. No.: 14/745,687

(22) Filed: Jun. 22, 2015

Related U.S. Application Data
(63) Continuation of application No. 14/510,636, filed on Oct. 9, 2014.
(60) Provisional application No. 61/897,933, filed on Oct. 31, 2013.

(51) Int. Cl. G06Q 30/06; G06Q 30/00; G06Q 10/08

(52) U.S. Cl. CPC G06Q 30/0635; G06Q 10/0875; G06Q 30/016

(57) ABSTRACT

According to an aspect, a method for retail store logistics management includes receiving information for pickup order fulfillment including items to be picked up and a store product location map indicating inventory locations and quantities in a retail store. Surveillance data for the store identifies high congestion areas on the sales floor. A pick list and a pickup route through the store are determined to efficiently collect the items on the pick list while avoiding the high congestion areas on the sales floor. The pickup route is displayed as an ordered list or as a route shown on a product location map of the store on a mobile device to guide a user of the mobile device along the pickup route while collecting the items on the pick list.

### DOMESTIC PRIORITY

The present application claims priority to U.S. Non-Provisional application Ser. No. 14/510,636 filed on Oct. 9, 2014 titled “LOGISTICS MANAGEMENT SYSTEM FOR DETERMINING PICKUP ROUTES FOR RETAIL STORES.” Which claims the benefits of U.S. Patent Application Ser. No. 61/897,933, filed on Oct. 31, 2013, entitled “SYSTEM AND METHOD FOR PICK FROM STORE”, the entire contents of which are incorporated herein by reference

### BACKGROUND

The present disclosure relates generally to retail store logistics systems, and more specifically pertains to a logistics management system that displays a pickup route on a product location map of the store to guide a store associate when collecting items for online order fulfillment.

The increase in popularity of online shopping has increased the competitive pressures on brick-and-mortar retail stores. While online stores have certain advantages, brick-and-mortar stores have the advantages of being physically located where their customers are located and having no shipping delay and no shipping costs required to place purchased items in the hands of their customers. As online retailers increase in popularity, brick-and-mortar stores are searching for ways to leverage their own advantages to thrive in the modern competitive environment.

### SUMMARY

Embodiments include a method, system, and computer program product for logistics management for retail stores. A method for retail store logistics management includes receiving information for pickup order fulfillment including items to be picked up and a store product location map indicating inventory locations and quantities in a retail store. Surveillance data identifies high congestion areas on the sales floor. A pick list and a pickup route through the store are determined to efficiently collect the items on the pick list while avoiding the high congestion areas on the sales floor. The pickup route is displayed as an ordered list or as a route shown on a product location map of the store on a mobile device to guide a user of the mobile device along the pickup route while collecting the items on the pick list.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a logistics management system for a retail store in accordance with an embodiment.

FIG. 2 depicts a logic flow diagram for a logistics management procedure for a retail store in accordance with an embodiment.

FIG. 3 depicts a logic flow diagram for receiving information for online order fulfillment in accordance with an embodiment.

FIG. 4 depicts a logic flow diagram for determining a pick list and pickup route in accordance with an embodiment.

FIG. 5 depicts an item pickup route for a retail store logistics management system in accordance with an embodiment.

FIG. 6 depicts a pickup order fulfillment itinerary in accordance with an embodiment.

FIG. 7 depicts a processing system suitable for implementing one or more components of the store logistics management system in accordance with an embodiment.

### DETAILED DESCRIPTION

Embodiments described herein relate to a logistics management system for a retail store. Pick lists and efficient pickup routes are designed based on sales floor conditions to avoid high congestion area and other sales floor restrictions. The system integrates a heavy load of online order fulfillment with conventional retail store business through efficient pickup routing for online orders. A pickup routing system receives online orders from a number of sources, such as orders received from telephone, websites, and mobile devices. Store cameras and other surveillance systems monitor store associate availability, sales floor restrictions, and sales floor congestion. The routing system schedules orders for pickup, generates an ordered list of items to be collected referred to as a “pick list,” and generates efficient pickup routes to guide store associates through the store in an efficient manner. In particular, pickup routes are designed to efficiently collect the items while avoiding sales floor restrictions and high congestion areas. Pickup routes are also scheduled to meet pickup order schedules while effectively utilizing store associates. The pickup route may be displayed as an ordered list or as a route shown on a product location map of the store on a mobile device to guide a user of the mobile device along the pickup route while collecting the items on the pick list. The pickup route may also be conferred to the picker via other means such as a paper printout.

Technical effects and benefits include an increased ability of a brick-and-mortar retail store to serve in part or in whole as an online order fulfillment center. Conventional retail stores have the advantage of stocking inventory nearby potential customers, which avoids shipping charges and shipping delays when filling online orders for customer pickup. Flexible and efficient pickup routing and scheduling for online orders allows the store to increase its role as an online order fulfillment center without unduly interfering with conventional sales floor activity. This allows brick-and-mortar retail stores to increase business, improve utilization of store associates, and compete more effectively with online retailers and other brick-and-mortar retail stores.

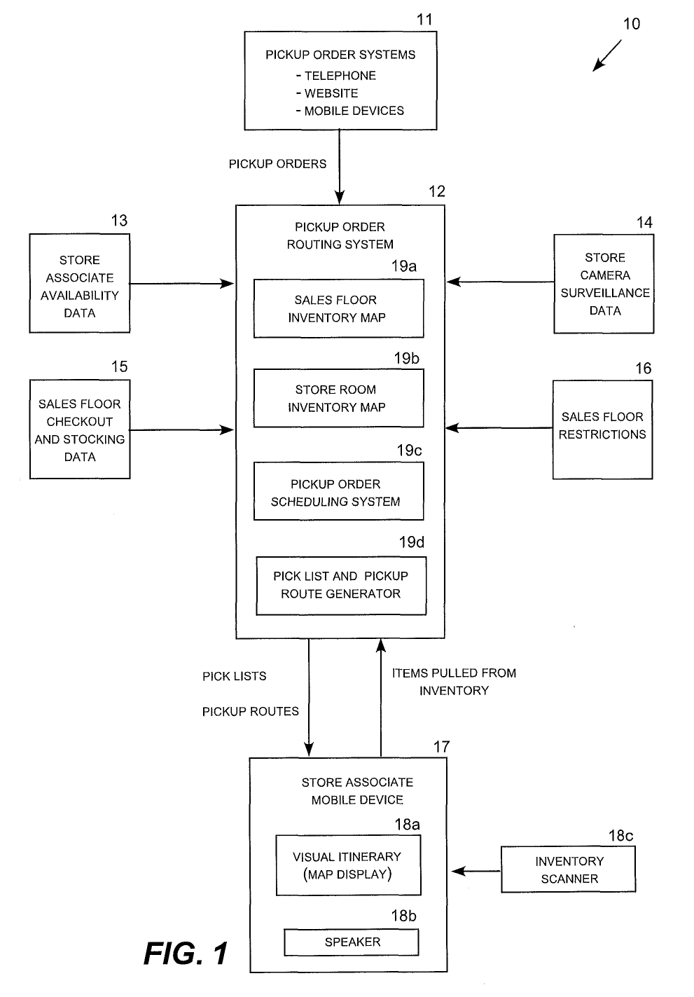

Turning now to FIG. 1, a logistics management system 10 for a brick-and mortar retail store includes online order systems 11, a pickup order routing system 12, and a store associate mobile device 17. The mobile device 17 runs a software application and includes a display 18a and optionally includes a speaker 18b and inventory control device 18c that allow the store associate to interact with the pickup order routing system 12 to manage the pickup order fulfillment process. The functionality of this embodiment is largely indifferent to the type computing devices or network architecture used to implement the functionality. In one particular embodiment, the pickup order routing system 12 may be a desktop or laptop computer running on a server and providing access to the mobile device 17 over a network, such as the Internet. The mobile device 17 may be a smartphone utilizing an app to access the pickup order routing system 12 over a wireless or other suitable network connection. As another example, the mobile device 17 may include a tablet or other type of computer mounted to a shopping cart that a store associates utilizes while collecting products to fulfill pickup orders. It will be appreciated that any other computer environment allowing a mobile device used by a store associate to communicate with a stationary or centralized logistics management system may be used to realize embodiments of the invention.

The pickup order systems 11 receive pickup orders from a number of sources. As shoppers become increasingly familiar with online shopping, a share of that business can be fulfilled by local brick-and-mortar stores. The retail store is therefore configured to receive pickup orders from a number of sources. Examples include orders received over the telephone, over a store website, and through ordering apps running on mobile devices. These sources are merely illustrative as the pickup order routing system is designed to increase the store's ability to serve as a pickup order fulfillment center regardless of the source of the pickup orders.

The pickup order routing system 12 receives the pickup orders along with a range of other information used to schedule and route product collection paths through the store for online order fulfillment. Examples include store associate availability monitoring system 13, which provides information regarding employees who have checked in for service and their work assignments within the store. Store associates who can be assigned to pickup order fulfillment may have other duties at other times, such as checkout, bagging, stocking, food preparation and so forth. As associates complete assignments they log their availability status with the pickup order routing system 12, for example logging their status into a mobile devices assigned to the associate. A mobile app may be provided allowing a smartphone or other device to provide store associate availability. The store associate availability may also be automatically inferred without requiring explicit logging, for example, monitoring activity by the associate on a point of sale system, video monitoring, or via wearable devices assigned to the associate. As another option, the store associate may report to a store manager who operates a central employee scheduling console for the store. Stores already have such systems, which can be configured to communicate with the pickup order routing system 12 through a suitable communication interface.

Store cameras 14 may also capture image data allowing the pickup order routing system 12 to identify areas in the store affected by high congestion, spills, and other conditions creating areas of the store to be avoided during pickup routing. The interface shown directly with the cameras may be replaced by a camera image recognition system providing the desired information. Other types of sales floor surveillance equipment, such as electric eyes and proximity sensors, can also be utilized in the system. Additionally congestions may be inferred via historical data or by explicit data entry (e.g. “meat counter area is always busy between 11 AM and 1 PM”). Additional surveillance techniques for determining congestion may include monitoring at the wireless connections, for example by counting how many customer devices with Bluetooth are present, counting how many customer devices with WiFi are present, counting how many users have recently scanned products in the area with a mobile scanner (e.g., store provided device or personal device), and so forth.

Sales floor checkout and stocking stations 15 provide inventory surveillance information to the pickup order routing system 12. Product inventory adjustments are entered as customers check items out through the sales floor checkout stations. Product scanners also enter inventory adjustments as items are moved from the store room onto the sales floor shelves, allowing the pickup order routing system to maintain a current manifest of the store's inventory. The pickup order routing system 12 keeps track of the quantities of products in specific store room and sales floor locations to enable detailed routing for product pickup. The interface shown directly with the sales floor checkout and stocking stations 15 may be replaced with an interface with an inventory management system if equivalent information is available through this type of system. The store may also increase the granularity of its barcode or RFID shelf space labeling to facilitate detailed inventory management and routing for pickup orders.

Sales floor restrictions 16 may also be provided to reflect conditions on the sales floor, such as aisle closing for stocking, floor cleaning, repairs, and other blockages or limitations to be taken into account in pickup routing. These specific considerations are merely illustrative and not intended to provide an exhaustive list. In general, any type of information that the store desires to have taken into account in pickup routing may be supplied to the pickup order routing system 12. Sales floor restrictions and congestion may be prioritized in the item collection process so that the more seriously affected areas are assigned higher area avoidance priority (lower area access priority) during item collection.

The pickup order routing system 12 also includes a sales floor product location map 19a indicating the locations of products and quantities available at the various locations on the retail sales floor. Similarly, a store room product location map 19b provides similar information for inventory located in the store room. The sales floor and store room maps provide a visual background for pickup routing. Sales floor locations are typically assigned higher area avoidance priority (lower area access priority) than store room locations during item collection. On the sales floor, special display areas are typically assigned higher area avoidance priority (lower area access priority) than inner aisle location during item collection.

A pickup order scheduling system 19c schedules orders for pickup in view of the store management information available to the pickup order routing system 12. Reasonable lead times are assigned for collecting the items for pickup orders and estimated order availability times are communicated to customers. Confirmation of pickup order availability may also be communicated to the customers when their orders are ready for pickup. Historical store traffic information and planned availability of store associates are important data items for estimating availability times for pickup orders. Customers may also indicate when they expect to pick up orders, for example after their work day. Of course, sufficient lead time should be afforded to avoid customers arriving before their pickup orders are ready.

Once the pickup orders are scheduled for fulfillment, the pick list and pickup route generator 19d generates the pick list and route for collecting the products to fulfill the orders. The items are ordered for collection along an efficient walking path through the store, which is also defined to avoid restricted and congested areas on the sales floor to the extent possible. Multiple pickup orders may be merged for collection and separated into pickup bins for customer pickup. Items are typically scheduled for collection from storage locations in a priority order. In particular, an item that is present in both the store room and on the sales floor is typically collected from the store room as the first priority. An item that is present in both a special display area (e.g., end cap location, entrance area display, checkout are display) and an inner aisle location is typically collected from the inner aisle location as the next priority. However, the inner aisle location may be avoided if that area of the sales floor is restricted or congested. Separate pick lists may be generated for different zones of the store, such as store room zone and one or more sales floor. For example, one or more orders may be divided and/or grouped into pick lists and routes for different store departments, which are sorted into individual orders after item collection. Pickup routing may also be based on parameters learned over time, such as routes that produce lower collection times, lower floor congestion, and fewer collection errors during operational experience using the system. While these considerations are merely illustrative, they are sufficient demonstrate the basic principles of the pick list and pickup routing functionality.

The pickup order routing system 12 transmits a pick list and pickup route to a store associate mobile device 17 assigned to the associate designated to collect the items. Alternatively, the pick list and pickup route may be transmitted to a mobile device mounted on a basket assigned for collecting the items. The screen 18a provides a visually intuitive illustration of the pickup route and pick list. As an option, the speaker 18b may also provide navigation instructions and/or routing cues for the associate. An inventory scanner 18c within or in communication with the mobile device 17 scans and logs items into the pickup collection basket. The screen 18a updates the pick route. As an option, the speaker 18b provides an audible confirmation when the proper items have been scanned into the pickup order. An error sound may be emitted when an incorrect item is scanned into the pickup order. As another option, the mobile device 17 may provide tactile indicators, such as vibrations, in addition or instead of audible indicators. The mobile device 17 also informs the pickup order routing system 12 as items are entered into the pickup order for inventory surveillance.

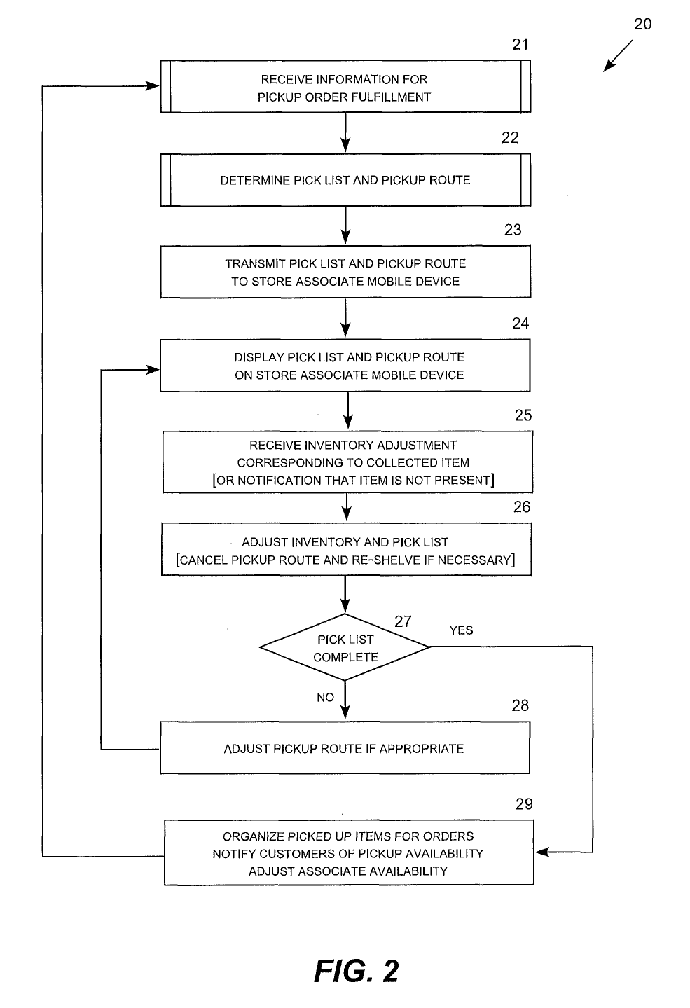

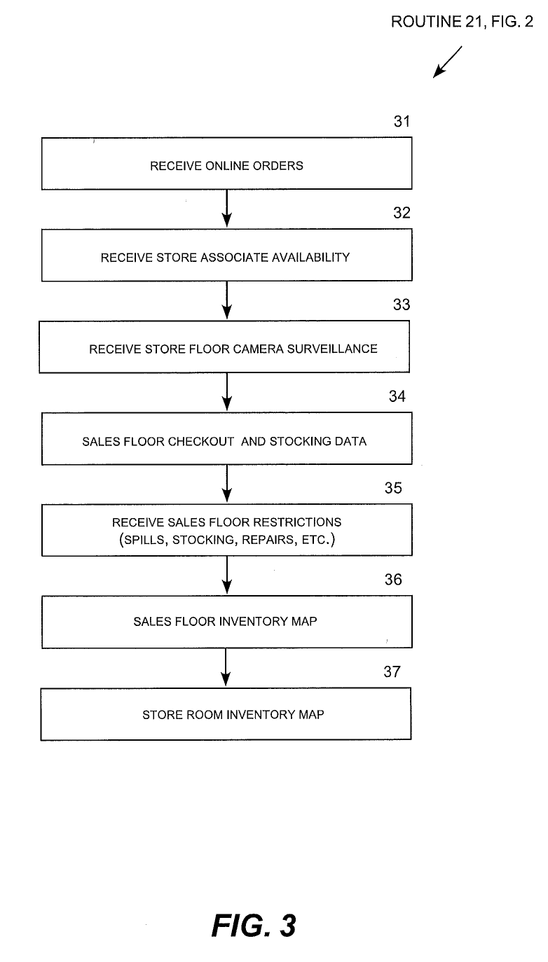

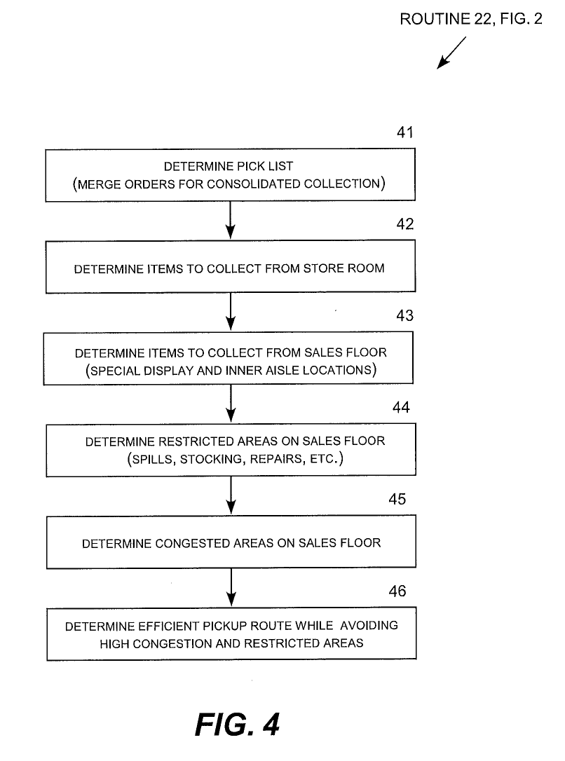

FIG. 2 depicts a logic flow diagram 20 for a retail store logistics management procedure in accordance with an embodiment. FIG. 1 will also be referenced in the following description of the methodology. In block 21, the pickup order routing system 12 receives information for pickup order fulfillment as described further with reference to FIG. 3. In block 22, the pickup order routing system 12 determines a pick list and pickup route as described further with reference to FIG. 4. The pick list and pickup route may be for a single pickup order or for multiple orders that are combined for item collection and separated afterwards for customer pickup. In block 23, the pickup order routing system 12 transmits the pick list and pickup route to a mobile device 17. In block 24, the pick list and pickup route are displayed and/or announced by the mobile device 17 to guide a store associate to collect the desired items along the desired route.

In block 25, the mobile device 17 logs an item into the pickup order basket and the mobile device or another inventory scanner transmits a corresponding inventory adjustment message to the pickup order routing system 12. In block 26, the mobile device 17 adjusts the pick list to reflect the item collected. Alternatively, in block 25 the picker may indicate that the item to be collected is not present in the expected location, for example due to an inventory record error, inventory being misplaced, or when a retail shopper has pulled an item from the shelf before a picker arrives to pull the same item. If a picker finds during a pickup route that an item or items associated with an order are not found in the expected location, then depending on the order fulfillment policy, the order may be fulfilled partially. In most cases, the partial fill is noted as the items are scanned into the pick list basket and the picker can continue to fill the order, and the missing item can be added to a customer's order at a later time. However, if the order is required to be picked together then either the order may be cancelled and rescheduled or assigned to other stores. If the order is canceled or reassigned, in block 26, the pick list is updated and the pickup route is updated to also include re-shelving of the items collected to that point corresponding to the canceled or reassigned orders.

In block 27, the pickup order routing system 12 determines whether the pick list has been fully collected. If there are items remaining on the pick list, the “yes” branch is followed to step 28, in which the pickup order routing system 12 may alter the pickup route if conditions on the floor have changed during the pickup process. The process then loops back to block 24 for continued item collection. If there no items remain on the pick list, the “no” branch is followed to step 29, in which the collected items are organized for customer pickup, which may involve separating merged orders into separate bins for the individual orders. The pickup order routing system 12 also notifies the customers whose orders are ready and adjusts the associate availability for the associate who just completed the pickup order fulfillment.

FIG. 3 depicts a logic flow diagram for block 21 on FIG. 2 for receiving information for pickup order fulfillment in accordance with an embodiment. In block 31, the pickup order routing system 12 receives pickup orders from the pickup order systems 11 for fulfillment from store inventory. In block 32, the pickup order routing system 12 receives store associate availability information 13 for assigning pickup orders to store associates for item collection. In block 33, the pickup order routing system 12 optionally receives store camera surveillance data 14 for reducing high congestion areas in item collection priority. In block 34, the pickup order routing system 12 receives sales floor checkout and stocking data 15 for inventory tracking. In block 35, the pickup order routing system 12 receives sales floor restrictions 16 for reducing the restricted areas on the sales floor in item collection priority. In block 36, the pickup order routing system 12 receives a sales floor product location map 19a for item pickup routing. In block 37, the pickup order routing system 12 receives a store room product location map 19a for item pickup routing.

FIG. 4 depicts a logic flow diagram for block 22 on FIG. 2 for determining a pick list and pickup route in accordance with an embodiment. In block 41, the pickup order routing system 12 determines a pick list for item collection, which may include merging orders for consolidated collection. In block 42, the pickup order routing system 12 determines items to be collected from the store room, which is usually the first priority for item collection. In block 43, the pickup order routing system 12 determines items to be collected from the sales floor. Inner aisle locations are usually the second priority for item collection with special display areas (e.g., end cap locations, entrance area displays, checkout are displays) usually considered to be the lowest priority for item collection. In block 44, the pickup order routing system 12 determines restricted areas on the sales floor, which are avoided if the products are available in other areas of the store. In block 45, the pickup order routing system 12 determines congested areas on the sales floor, which are also avoided if the products are available in other areas of the store. The pickup order routing system 12 may also determine item characteristics, such as perishability, expiration date, size, weight, and quantity of an item to be collected. Perishable items may be picked last to preserve freshness. Voluminous or heavy items may take more time to be picked and hence be picked up early. In block 46, the pickup order routing system 12 determines an efficient pickup route for the pick list taking all of these factors into account.

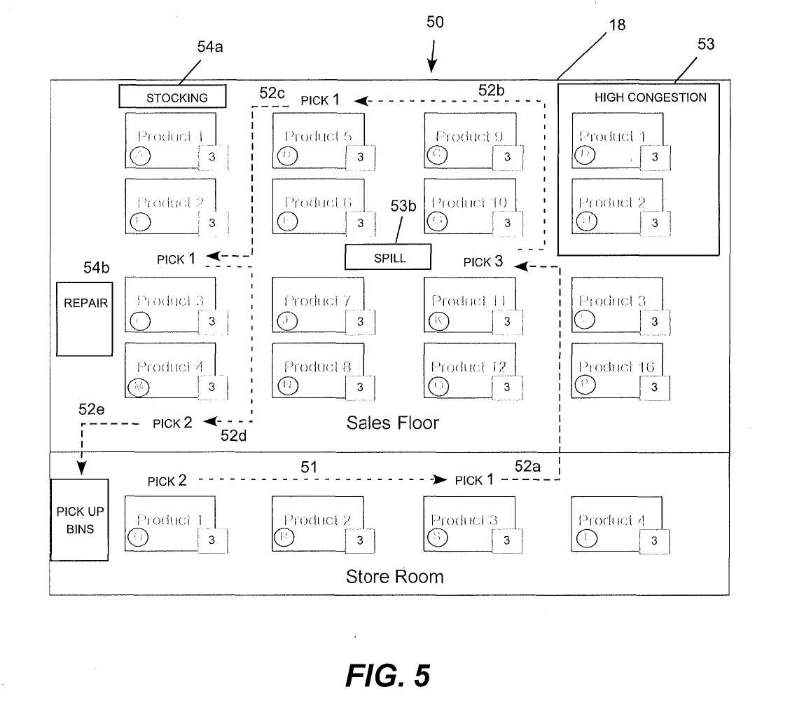

FIG. 5 depicts an item pickup route 50 provided on the display 18a of the mobile device 17 carried by a store associate in accordance with an embodiment. The pickup route 50 shows a path for an associate to walk through the store while collecting the items on the pick list. The map also identifies the items and quantities to be picked up at the various storage locations. Each collection area indicates the type and number of items to be collected. The order of item pickup and the pickup route are designed to minimize the length of the pickup route while avoiding the restricted and congested areas to the extent possible. The walking path includes location-to-location paths 52a-e that guide the associate along an efficient collection route through a store room and a retail sales floor area. The pickup route avoids the high congestion area 53 and the restricted areas 54a-54b if possible.

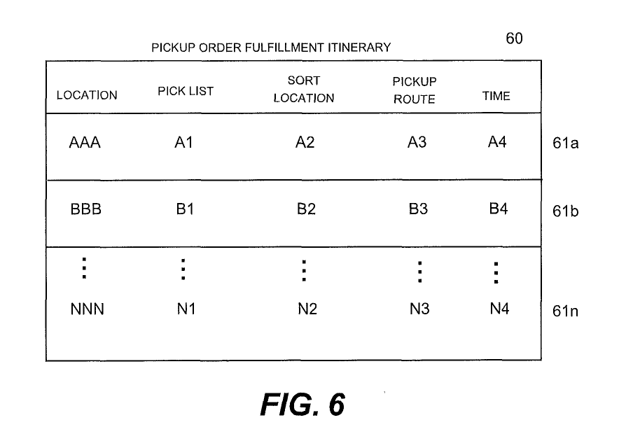

FIG. 6 depicts a pickup order fulfillment itinerary 60 for the pickup order routing system 12 in accordance with an embodiment. This example includes a list of itinerary records 61a-n that each include a number of itinerary items. Each itinerary record includes a location (e.g., store zone or department), a pick list (which may be a complete order, a partial order, or a merged order containing items from multiple customer orders), one or more sort locations (e.g., bins, lockers or other designation where customer orders are assembled and held for pickup by the customers), a pickup route, and an assigned time. Each itinerary item in this example is depicted as a link that can be selected to obtain additional information. To illustrate the type of information that may be available, the location link may be selected to obtain a product location map for the store showing the zone or department where the items on the associated pickup list are located. The pick list link may be selected to obtain a listing of the items and quantities to be collected in the order assigned. The sort location link may be selected to obtain a map of the pickup bins or lockers showing the assignment of the items on the pick list into the assigned sort locations. An RFID reader housed in or cooperating with the mobile device 17 may be provided to simultaneously read the tags on multiple items in a pickup bin or locker to confirm that customer's order has been properly assembled. The pickup route link may be selected to obtain a product location map of the store showing the pickup route to be walked when collecting the items on the associated pick list.

The itinerary 61a-n for each pick list is updated as items are collected and scanned initially into a pick list collection basket and finally into the assigned pickup bin(s) or locker(s). This provides a running status of each pick list as the collection process is in progress, which provides the pickup order routing system 12 with complete situational awareness of the item pickup and sort process at all times. For example, this allows the pickup process to be easily paused and resumed where it was left off, potentially by a different store associate, if the pickup and sort process is interrupted for any reason. The process also allows individual customer orders to be assembled from a number of pick lists, which may executed at different times or different locations and sorted into a common collection point, such as bin or locker, assigned to that particular order. It will therefore be appreciated that the items for a particular customer order may be located in several different locations, such as different departments within a store, different physical stores, possibly in a warehouse or distribution center, and potentially even in a competitor or partner store (for example if the item is back ordered at the retailer). In each location, a portion of the customer's order may be merged with other orders (or parts of orders), which the items sorted into respective consolidation points for each order.

In addition, the pick list procedure is not limited to customer orders, but may be used to collect and consolidate defined sets of products for any purpose. Representative examples include collecting items for consolidated return, collecting items for stocking pop-up stores or store areas, collecting items for special display areas, collecting items for in-store product demonstrations, collecting items for donation, collecting expired items, collecting items for a meeting or other gathering in the store, and the like. As another aspect, the ordering of items to be collected in a particular pick list and the order in which pick lists are scheduled for collection may depend on item characteristic, such as the perishablity, expiration date, size, weight, or quantity of the items to be collected.

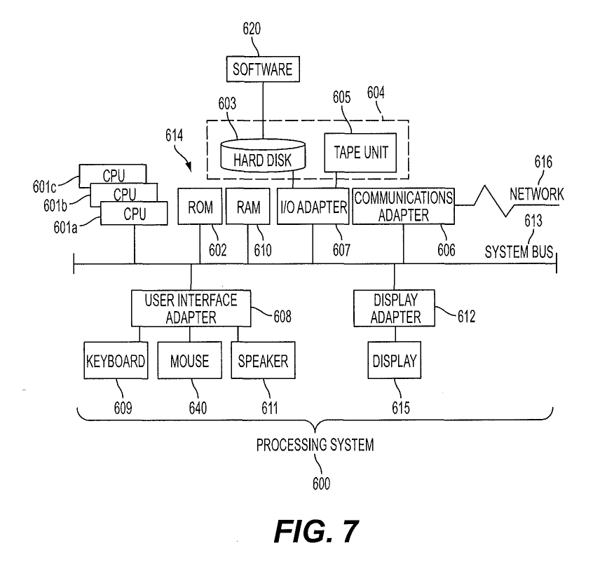

FIG. 7 depicts a processing system suitable for implementing the store logistics management system in accordance with an embodiment. The pickup ordering system 11, the pickup routing system 12, and the store associate mobile device 17 may each be configured as described below. It will be appreciated that this particular computer configuration is merely illustrative and wide range of platforms can be used to implement these components as a matter of design choice.

Referring now to FIG. 7, there is shown an embodiment of a processing system 600 for implementing the teachings herein. In this embodiment, the processing system 600 has one or more central processing units (processors) 601a, 601b, 601c, etc. (collectively or generically referred to as processor(s) 601). Processors 601, also referred to as processing circuits, are coupled to system memory 614 and various other components via a system bus 613. Read only memory (ROM) 602 is coupled to system bus 613 and may include a basic input/output system (BIOS), which controls certain basic functions of the processing system 600. The system memory 614 can include ROM 602 and random access memory (RAM) 610, which is read-write memory coupled to system bus 613 for use by processors 601.

FIG. 7 further depicts an input/output (I/O) adapter 607 and a network adapter 606 coupled to the system bus 613. I/O adapter 607 may be a small computer system interface (SCSI) adapter that communicates with a hard disk 603 and/or tape storage drive 605 or any other similar component. I/O adapter 607, hard disk 603, and tape storage drive 605 are collectively referred to herein as mass storage 604. Software 620 for execution on processing system 600 may be stored in mass storage 604. The mass storage 604 is an example of a tangible storage medium readable by the processors 601, where the software 620 is stored as instructions for execution by the processors 601 to perform a method, such as the process flow of FIGS. 2-4. Network adapter 606 interconnects system bus 613 with an outside network 616 enabling processing system 600 to communicate with other such systems. A screen (e.g., a display monitor) 615 is connected to system bus 613 by display adapter 612, which may include a graphics controller to improve the performance of graphics intensive applications and a video controller. In one embodiment, adapters 607, 606, and 612 may be connected to one or more I/O buses that are connected to system bus 613 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 613 via user interface adapter 608 and display adapter 612. A keyboard 609, mouse 640, and speaker 611 can be interconnected to system bus 613 via user interface adapter 608, which may include, for example, a Super I/O chip integrating multiple device adapters into a single integrated circuit.

Thus, as configured in FIG. 7, processing system 600 includes processing capability in the form of processors 601, and, storage capability including system memory 614 and mass storage 604, input means such as keyboard 609 and mouse 640, and output capability including speaker 611 and display 615. In one embodiment, a portion of system memory 614 and mass storage 604 collectively store an operating system such as the AIX® operating system from IBM Corporation to coordinate the functions of the various components shown in FIG. 7.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for store logistics management, comprising:
receiving information for pickup order fulfillment including items to be picked up;
receiving a store product location map indicating inventory locations and quantities in a retail store;
receiving surveillance data for the store identifying high congestion areas on the sales floor;
determining a pick list for pickup order fulfillment;
determining a pickup route through the store to efficiently collect the items on the pick list while avoiding the high congestion areas on the sales floor; and
displaying the pickup route as an ordered list or a route showing a product location map of the store on a mobile device to guide a user of the mobile device along the pickup route while collecting the items on the pick list.

2. The method of claim 1, further comprising ordering the pick list based on an item characteristic comprising perishability, expiration date, size, weight, or quantity of an item to be collected.

3. The method of claim 1, further comprising receiving information indicating restricted areas of the sales floor and determining the pickup route to avoid the restricted areas.

4. The method of claim 1, further comprising assigning items located in a store room a higher collection priority than items stored on a sales floor when placing items on the pick list and assigning items located in inner shelf areas on a sales floor a higher collection priority than items stored in a special display area on the sales floor when placing items on the pick list.

5. The method of claim 1, further comprising dividing one or more pickup orders into multiple zone pick lists and associated zone pickup routes corresponding to respective zones of the store.

6. The method of claim 1, further comprising combining all or portions of multiple online orders from multiple customers when determining the pick list.

7. The method of claim 1, further comprising receiving sales associate availability information and scheduling item collection for pickup order fulfillment based in part on the sales associate availability information.

8. The method of claim 1, further comprising receiving an indication that an item is not present for collection as indicated on the pick list, cancelling the items from pick list, and updating the pickup route to also account for re-shelving the items collected for the canceled pick list.

9. The method of claim 1, further comprising generating the pickup route based on one or more parameters learned over time.
